(19) United States
(12) Patent Application Publication
(10) Pub. No.: US 2010/0090493 A1
(43) Pub. Date: Apr. 15, 2010

(54) ARRANGEMENT FOR ATTACHING THE SEAT OF AN AUTOMOBILE

(75) Inventor: Olivier Rioult, Voisins Le Bretonneux (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., BOULOGNE-BILLANCOURT (FR)

(21) Appl. No.: 12/529,351

(22) PCT Filed: Mar. 3, 2008
(86) PCT No.: PCT/FR08/50355

§ 371 Date: Nov. 23, 2009

(30) Foreign Application Priority Data
Mar. 6, 2007 (FR) 0753659

(51) Int. Cl. B60N 2/00

(52) U.S. Cl. 296/64

(57) ABSTRACT

The invention relates to an arrangement for attaching a seat (1) relative to a structural member of the body of a vehicle, in which at least one locking member (10) is capable of securing said seat (1) and is connected to a holding member (12, 13), said holding member (12, 13) being maintained in position relative to the structural member (2) of the body, characterised in that the holding member (12, 13), the floor (4) of the vehicle and the structural member (2) are connected by a common welding (22).

The present invention relates to an arrangement for attaching the seat and more specifically to an arrangement for attaching a seat with respect to a vehicle bodyshell structural element, in which at least one locking means is able to attach said seat and is secured to a support element, this support element being held in position with respect to the bodyshell structural element.

It is known practice, when attaching seats, to use locking systems welded to elements secured to the vehicle bodyshell.

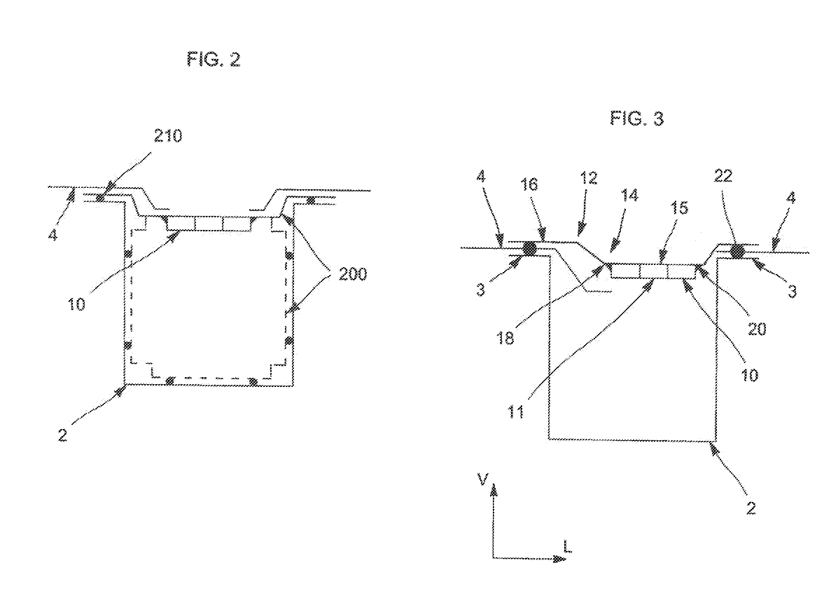

In the conventional way, and as depicted in FIG. 2, these locking systems are associated with the vehicle bodyshell via a housing 200 welded 210 into a crossmember 2. These locking systems have the disadvantage of adding to the structure of the vehicle components that adversely affect the volume allocated in the region and/or adversely affect the mass of the vehicle. In this known arrangement, the floorpan 4 rests on the housing 200. Only the crossmember 2 and the housing 200 are welded by common spot welds, because of the small thickness of the floorpan and the risk of damaging it.

One of the objectives of the invention is therefore to propose an arrangement for attaching the seat which provides a reliable attachment of the seat, capable of withstanding load but which, in response to objectives invariably encountered with the various motor manufacturers, is inexpensive and not very bulky.

In order to meet these objectives, the invention proposes an arrangement as described hereinabove, and characterized in that the support element, the vehicle floorpan and the structural element are secured together by a common weld.

According to various features of the present invention:
the floorpan is positioned between the support element and the structural element;
the locking means is a cylindrical element, and in that it is welded to the support element by three welded seams positioned 120° apart;
the support element is in the form of a plate comprising substantially flat edges and a central part formed of at least one pressing with which at least one locking means is associated;
the pressing is directed vertically so that, when the edges of the support element are secured to the rebates of the crossmember, the pressing and the corresponding locking means are situated within the volume of the structural element;
two separate support elements are positioned on one and the same structural element, each support element bearing a locking element able to attach the same vehicle seat.

The invention is also aimed at a motor vehicle, which comprises two independent seats attached with an arrangement as described above, and which comprises three support elements, one of these being a central support element comprising two locking means.

Other features and advantages of the invention will become apparent from reading the detailed description which follows, for an understanding of which reference will be made to the attached drawings in which:

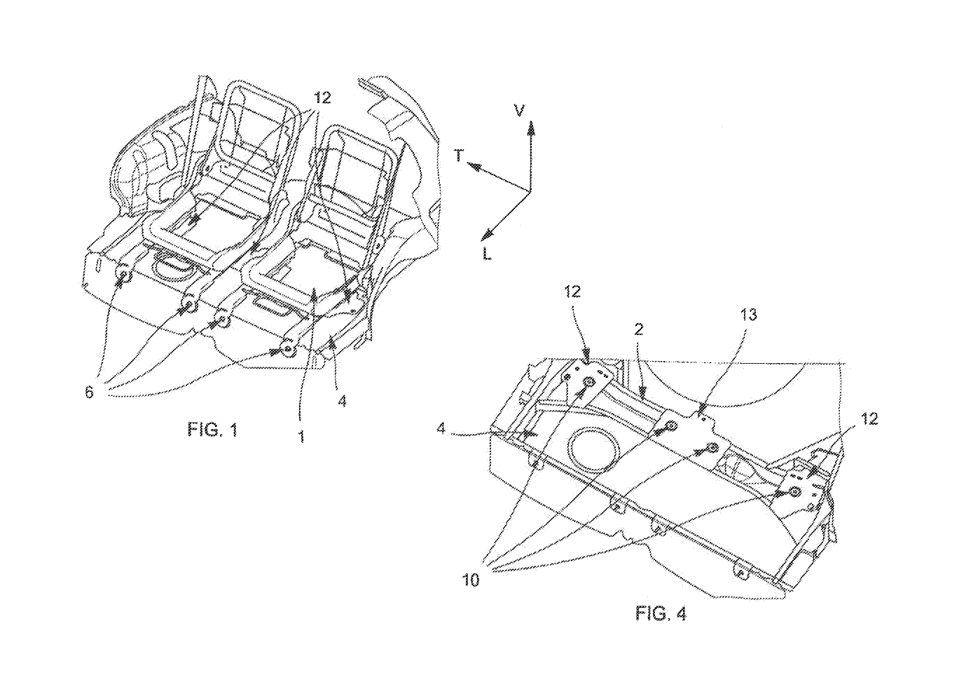

FIG. 1 is a schematic depiction of an independent rear seat assembly and of an arrangement for attaching these seats according to the present invention;

FIG. 2 is a depiction of an attachment arrangement according to the prior art;

FIG. 3 is a view in cross section through the attachment arrangement depicted in FIG. 1;

FIG. 4 is a depiction of the attachment arrangement of FIG. 1, without the seat assembly;

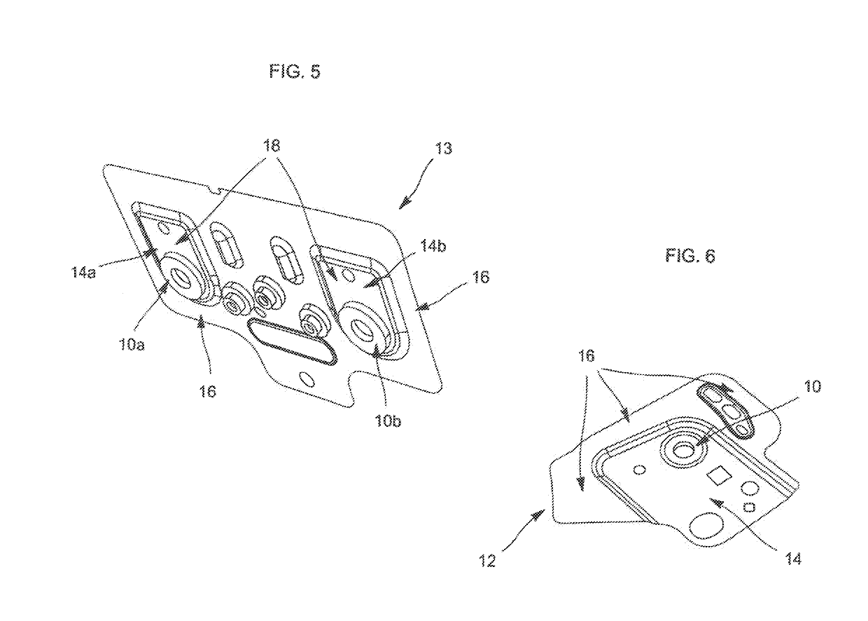

FIG. 5 is a schematic depiction of a central support element according to the invention, viewed from beneath;

FIG. 6 is a schematic depiction of a lateral support element, viewed from above.

In the description which will follow, a longitudinal, vertical and transverse orientation according to the traditional orientation used in motor vehicles and indicated by the trihedron L, V, T in FIG. 1, will be adopted nonlimitingly.

The present invention is aimed at protecting an arrangement for attaching a motor vehicle seat 1. In the exemplary embodiment which will follow, the attachment arrangement is described in relation to a rear seat 1 independent of a second rear seat. It will be appreciated that this arrangement can be applied to any vehicle seat, particularly a front seat, or to a rear bench seat, and that an attachment arrangement according to the invention may be combined with other means of attachment for the other attachment points of this same seat.

As depicted in FIG. 1, a seat 1 is attached by two front attachment points 6 screwed in the known way into the structure of the vehicle and two rear attachment points. These two rear attachment points are made up of two locking systems associated with the seat, and not depicted, by way of example systems of the so-called “ballfix” type, these locking systems being able to collaborate with locking means 10 associated with the bodyshell structure.

According to the present invention, the locking means 10 are welded to a support element 12, 13. As depicted in FIGS. 1 and 4, a single locking means 10 may be associated with a single support element 12, or at least two locking means 10 may be welded to one and the same support element 13.

According to the present invention, each locking means 10 is in the form of a cylindrical element, equipped at its center with a bore 11 able to collaborate with the locking systems associated with the seat 1 and which have not been depicted. Each cylindrical element rests against the underside 18 of a support element 12, 13 and is positioned in such a way that the bore 11 of the cylindrical element that forms the locking means 10 corresponds with an orifice 15 created in the support element 12, 13 so that the locking system associated with the seat can be inserted into this bore 11 through a downward vertical action.

The dimensions of each orifice 15 in the support elements 12, 13 are designed so that, on the one hand, the bore 11 of the locking means 10 is completely uncovered and accessible and, on the other hand, welded seams 20 can be created where the underside 18 of the support element 12, 13 makes contact with the periphery of the cylindrical element that forms the locking means 10. According to one embodiment of the invention, three arc welded seams 20 are created to secure the cylindrical element that forms the locking means 10 to the support element 12, 13. These three welded seams 20 are then arranged uniformly about the periphery of the cylindrical element, 120° apart. By way of example, these welded seams may be SMAW seams produced by gas-shielded metal arc welding.

The longitudinal dimension of each support element 12, is at least equal to the longitudinal dimension of the corresponding structural element 2 so that the edges 16 corresponding to the longitudinal ends of each support element can rest on and be attached to rebates 3 of the corresponding structural element 2.

According to the invention, each support element 12, 13 is formed of a plate with substantially flat edges 16 and at least one central part formed by a pressing 14 so that this central part is situated in a plane that lies lower than the plane containing the edges 16 of the plate and therefore of the rebates 3 of the corresponding structural element 2. As depicted in FIG. 3, the underside 18 of this central part, to which the locking means 10 is welded, is then positioned substantially within the volume of the corresponding structural element 2 when the support element 12, 13 is secured to this structural element 2. A position such as this is advantageous in numerous respects, because it makes it possible, on the one hand, to influence the ultimate vertical position of the occupant of the seat and also improves the ability of the seat 1 to withstand load. Specifically, the fact that the locking means 10 is as close as possible to the corresponding structural element 2 introduces lower moments by comparison with an arrangement in which the locking means 10 is raised up.

According to one embodiment of the invention which has been depicted in FIGS. 4, 5 and 6, a central support element 13 is positioned transversely substantially at the center of the crossmember that forms the corresponding structural element 2 and bears two locking means 10. Two lateral support elements 12 are positioned transversely substantially at the ends of the crossmember, and each bears a locking means 10. In the various instances, each support plate comprises, according to the invention, a pressing 14 to the underside 18 of which the locking means 10 is welded. The central support element 13 thus comprises, as depicted more specifically in FIG. 5, two separate pressings 14a, 14b with which a locking means 10a, 10b is associated. However, it will be appreciated that, without departing from the context of the invention, a single pressing could be formed in the central support plate, this single pressing bearing the two locking means associated with the central support plate.

Each support element 12, 13 is welded to the floorpan 4 and to the corresponding structural element 2 by spot welds 22 capable of welding three thicknesses. As depicted in FIG. 4, the stacking in the arrangement is such that the floorpan 4 is positioned between the support plate 12, 13 and the rebates 3 of the corresponding structural element 2 and three-thickness spot welds 22 can therefore be produced, because the heat given off during welding does not directly affect the floorpan 4 but affects the top component, namely the support plate 12, 13, the material and thickness of which are able to withstand the released heat.

The magnitude of the support elements 12, 13 in the transverse direction allows enough three-thickness spot welds 22 to be welded that the assembly is able to withstand the various loading scenarios.

Each spot weld 22 is therefore produced in order to weld together three thicknesses: the corresponding structural element 2, the vehicle floorpan 4, and the plate 12, 13 bearing the locking system 10. In the example depicted in the figures, the corresponding structural element 2 is the rear central crossmember and the floorpan is cut to allow the support plate and the locking means through.

The invention is not in any way restricted to the embodiment described and illustrated which has been given merely by way of example.

1-7. (canceled)

8. An arrangement for attaching a seat with respect to a vehicle bodyshell structural element, comprising:
at least one locking means to attach the seat and being secured to a support element, the support element being held in position with respect to the bodyshell structural element,
wherein the support element, the vehicle floorpan, and the structural element are secured together by a common weld.

9. The arrangement as claimed in claim 8, wherein the floorpan is positioned between the support element and the structural element.

10. The arrangement as claimed in claim 8, wherein the locking means includes a cylindrical element, and is welded to the support element by three welded seams positioned 120° apart.

11. The arrangement as claimed in claim 8, wherein the support element is in a form of a plate comprising substantially flat edges and a central part formed of at least one pressing with which at least one locking means is associated.

12. The arrangement as claimed in claim 11, wherein the pressing is directed vertically so that, when edges of the support element are secured to rebates of the structural element, the pressing and the corresponding locking means are situated within the volume of the structural element.

13. The arrangement as claimed in claim 8, wherein two separate support elements are positioned on one and the same structural element, each support element bearing a locking element to attach the same vehicle seat.

14. A motor vehicle, comprising:
two independent seats attached with an arrangement as claimed in claim 8; and
three support elements, one of the support elements being a central support element comprising two locking means.
